(19) United States
(12) Patent Application Publication
(10) Pub. No.: US 2017/0045084 A1
(43) Pub. Date: Feb. 16, 2017

(54) BEARING STRUCTURE AND TURBOCHARGER

(71) Applicant: IHI CORPORATION, KOTO-KU (JP)

(72) Inventors: YUTAKA UNEURA, TOKYO (JP); SHINICHI KANEDA, TOKYO (JP); YUICHI DAITO, TOKYO (JP); HIDEYUKI KOJIMA, TOKYO (JP); TOMOMI SUGIURA, TOKYO (JP); KENJI BUNNO, TOKYO (JP)

(73) Assignee: IHI CORPORATION, KOTO-KU (JP)

(21) Appl. No.: 15/339,288

(22) Filed: Oct. 31, 2016

Related U.S. Application Data
(63) Continuation of application No. PCT/JP2015/071066, filed on Jul. 24, 2015.

(30) Foreign Application Priority Data
Aug. 21, 2014 (JP) 2014-168257

(51) Int. Cl. F16C 33/10; F16C 35/02; F16C 17/18; F02B 39/14; F16C 17/26

(52) U.S. Cl. CPC F16C 33/1045; F02B 39/14; F16C 17/26; F16C 17/18; F16C 35/02; F16C 2360/24

(57) ABSTRACT

A bearing structure includes a bearing holder that has a hollow main body and an oil hole penetrating through from an outer circumferential surface to an inner circumferential surface of the main body to thereby guide a lubricating oil to the inside of the main body, and that is fixed in a bearing housing; two full-floating metal bearings that are arranged separated from each other in the axial direction of the shaft and support the shaft, in the bearing holder; two thrust bearing surfaces each arranged on the outside of two full-floating metal bearings in the axial direction of the shaft; and two collars each arranged on the outside of two thrust bearing surfaces in the axial direction of the shaft and provided for the shaft. The lubricating oil lubricates thrust bearing surfaces after lubricating full-floating metal bearings.

### CROSS REFERENCE TO RELATED APPLICATIONS

This application is a continuation application of International Application No. PCT/JP2015/071068, filed on Jul. 24, 2015, which claims priority to Japanese Patent Application No. 2014-168257, filed on Aug. 21, 2014, the entire contents of which are incorporated by reference herein.

### BACKGROUND

1. Technical Field

The present invention relates to a bearing structure in which a shaft is supported by a full-floating metal bearing, and to a turbocharger.

2. Description of the Related Art

Heretofore, there is known a turbocharger in which a shaft is supported rotatably by a bearing housing and the shaft is provided with a turbine wheel at one end of the shaft and a compressor wheel at the other end of the shaft. Such turbocharger is connected to an engine, and the turbine wheel is rotated by exhaust gas discharged from the engine, and the compressor wheel is rotated by the rotation of the turbine wheel via the shaft. In this way, the turbocharger compresses air with the rotation of the compressor wheel and sends the air to the engine.

The turbocharger described in Japanese Patent No. 4407780 (Patent Document 1) uses two full-floating metal bearings as bearings for supporting a shaft. Two full-floating metal bearings are accommodated in a bearing holder fixed in a bearing housing. On the compressor wheel side of the bearing holder, a thrust bearing that receives a thrust load is arranged. To the bearing housing and the bearing holder, an oil path of lubricating oil is formed. The oil path branches off toward two full-floating metal bearings and the thrust bearing, and lubricating oil is supplied to respective bearings through respective branch passes.

### SUMMARY

Incidentally, temperature on the compressor wheel side is lower than that on the turbine wheel side in which discharge gas at high temperatures circulates. Therefore, in the configuration in which a bearing holder is provided as described in Patent Document 1, lubricating oil supplied to the thrust bearing has a comparatively low temperature and has high viscosity. Consequently, influence of viscous resistance of the lubricating oil on mechanical loss is large. Accordingly, development of a mechanism capable of further reducing mechanical loss is desired.

A purpose of the present invention is to provide a bearing structure capable of reducing mechanical loss caused by lubricating oil, and a turbocharger.

A first aspect of the present invention is a bearing structure of a turbocharger including a shaft provided with wheels at both ends, and a housing in which the shaft is accommodated and an oil path for guiding lubricating oil is formed in the inside of the housing, comprising: a bearing holder fixed in the housing, the bearing holder having a hollow main body provided with an outer circumferential surface and an inner circumferential surface, and an oil hole penetrating through from the outer circumferential surface to the inner circumferential surface of the main body and communicating with the oil path to thereby guide the lubricating oil to the inside of the main body; two full-floating metal bearings configured to support the shaft, the full-floating metal bearings being arranged in the bearing holder and separately provided from each other in an axial direction of the shaft; two thrust bearing surfaces each arranged on an outside of the two full-floating metal bearings in the axial direction of the shaft; and two collars each arranged on an outside of the two thrust bearing surfaces in the axial direction of the shaft and provided for the shaft.

The bearing structure may further have a thrust bearing including the thrust bearing surface, the thrust bearing being provided as a body separated from the bearing holder and being fixed to the bearing holder.

An opening of the oil hole on an inner circumferential surface side of the main body of the bearing holder may lie between the two full-floating metal bearings in the axial direction of the shaft. The two full-floating metal bearings may have a metal main body in a cylindrical shape and an oil guide hole that penetrates through from the outer circumferential surface to the inner circumferential surface of the metal main body and guides the lubricating oil from the inner circumferential surface toward the outer circumferential surface.

An opening of the oil hole on an outer circumferential surface side of the main body may lie at a position different from that of an opening of the oil path on the bearing holder side formed to the housing, in a circumferential direction of the shaft.

A second aspect of the present invention is a turbocharger including the bearing structure according to the first aspect.

According to the present invention, it is possible to reduce mechanical loss caused by lubricating oil.

### BRIEF DESCRIPTION OF THE DRAWINGS

FIG. 1 is a schematic cross-sectional view of a turbocharger according to an embodiment of the present invention.

FIG. 2 is a drawing for explaining the bearing structure according to the embodiment.

FIG. 3 is a drawing for explaining the flow of lubricating oil in the embodiment.

FIG. 4 is a drawing for explaining a flow of lubricating oil in a modified example of the embodiment.

### DESCRIPTION OF THE EMBODIMENTS

Hereinafter, an embodiment of the present invention will be explained in detail with reference to the attached drawings. Dimensions, materials, concrete numerical values etc. shown in such embodiment are nothing but exemplifications for making understanding of the invention easy, and do not limit the present invention unless otherwise noted in particular. Note that, in the description and drawings, to components having substantially the same function or configuration, the same sign is attached and repeated explanation is omitted, and diagrammatic representation of components having no direct relationship to the present invention is omitted.

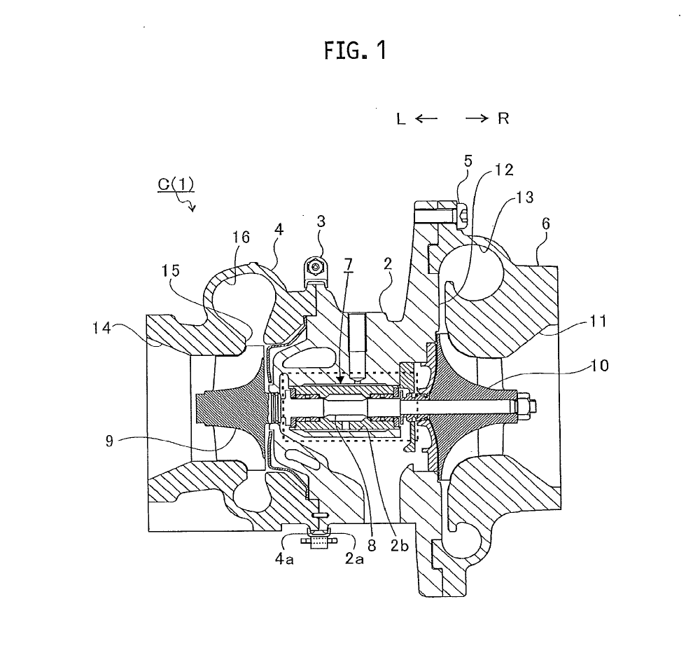

FIG. 1 is a schematic cross-sectional view of a turbocharger C. In what follows, explanation will be given with a definition that an arrow L shown in FIG. 1 shows the direction of the left side of the turbocharger C, and that an arrow R shows the direction of the right side of the turbocharger C. As shown in FIG. 1, the turbocharger C includes a turbocharger main body 1. The turbocharger main body 1 has a bearing housing 2, a turbine housing 4 coupled to the left side of the bearing housing 2 with a fastening mechanism 3, and a compressor housing 6 coupled to the right side of the bearing housing 2 with a fastening bolt 5. These are integrated.

A projection 2a is provided for the outer circumferential surface near the turbine housing 4 of the bearing housing 2. The projection 2a projects in the radial direction of the bearing housing 2. Further, a projection 4a is provided for the outer circumferential surface near the bearing housing 2 of the turbine housing 4. The projection 4a projects in the radial direction of the turbine housing 4. The bearing housing 2 and the turbine housing 4 are fixed to one another by band-fastening of the projections 2a and 4a with the fastening mechanism 3. The fastening mechanism 3 is configured from a fastening band (such as G coupling) sandwiching the projections 2a and 4a.

A bearing structure 7 is provided for the bearing housing 2. Specifically, a through-hole 2b penetrating through in the left and right direction of the turbocharger C (the axial direction of a shaft 8) is formed in the bearing housing 2, and the shaft 8 is supported rotatably in the through-hole 2b. The bearing structure 7 will be described in detail later.

A turbine wheel 9 is fixed integrally to the left end part (one end, a first end part) of the shaft 8, and the turbine wheel 9 is accommodated rotatably in the turbine housing 4. Further, a compressor wheel 10 is fixed integrally to the right end part (the other end, a second end part) of the shaft 8, and the compressor wheel 10 is accommodated rotatably in the compressor housing 6.

An intake port 11 is formed in the compressor housing 6. The intake port 11 opens on the right side of the turbocharger C, and is connected to an air cleaner (not illustrated). Further, in a state where the bearing housing 2 and the compressor housing 6 are coupled with the fastening bolt 5, surfaces of both housings 2 and 6 facing each other form a diffuser passage 12 that boosts air pressure. The diffuser passage 12 is formed in an annular shape from the inside toward the outside of the shaft 8 in the radial direction. The diffuser passage 12 is communicated with the intake port 11 via the compressor wheel 10, in the inside of the radial direction.

A compressor scroll passage 13 is provided in the compressor housing 6. The compressor scroll passage 13 is formed in an annular shape, and is located on the outside of the shaft 8 (the compressor wheel 10) in the radial direction of the diffuser passage 12. The compressor scroll passage 13 is communicated with an intake port (not illustrated) of the engine. Further, the compressor scroll passage 13 is also communicated with the diffuser passage 12. Accordingly, when the compressor wheel 10 rotates, the air is sucked into the compressor housing 6 from the intake port 11, is accelerated caused by the operation of centrifugal force while the air flows between blades of the compressor wheel 10, is boosted in pressure in the diffuser passage 12 and the compressor scroll passage 13, and is guided to an intake port of the engine.

A discharge port 14 is formed in the turbine housing 4. The discharge port 14 opens on the left side of the turbocharger C, and is connected to an exhaust gas purification device (not illustrated). A passage 15 and an annular-shaped turbine scroll passage 16 located on the outside of the passage 15 in the radial direction of the shaft 8 (the turbine wheel 9) are provided for the turbine housing 4. The turbine scroll passage 16 is communicated with a gas inflow port (not illustrated) to which exhaust gas discharged from an exhaust manifold (not illustrated) of the engine is guided. Further, the turbine scroll passage 16 is also communicated with the passage 15. Accordingly, the exhaust gas is guided from the gas inflow port to the turbine scroll passage 16, and thus guided to the discharge port 14 via the passage 15 and the turbine wheel 9. In the circulation process, the exhaust gas rotates the turbine wheel 9. The turning force of the turbine wheel 9 is transmitted to the compressor wheel 10 via the shaft 8, thereby rotating the compressor wheel 10. The air is boosted in pressure by the turning force of the compressor wheel 10 and is guided to the intake port of the engine.

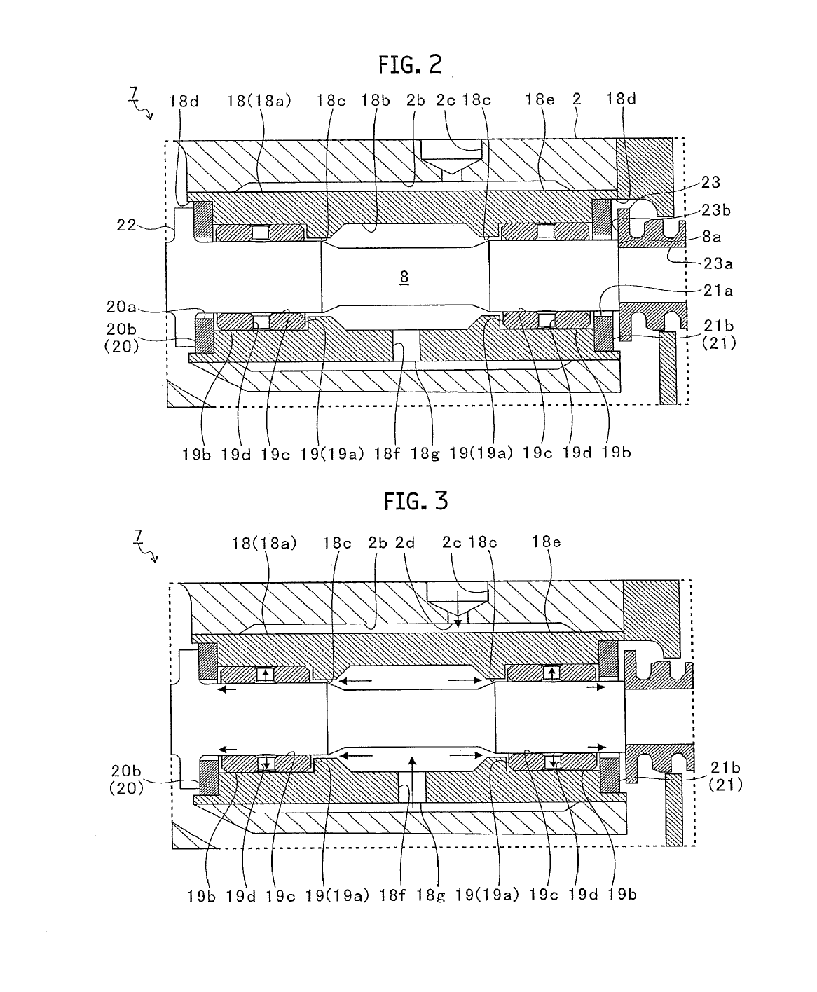

FIG. 2 is a drawing for explaining the bearing structure 7, and shows the broken line part abstracted from FIG. 1. As shown in FIG. 2, the bearing structure 7 includes a bearing holder 18 accommodated in the through-hole 2b of the bearing housing 2. The bearing holder 18 has a main body 18a in a hollow shape (i.e. hollow cylindrical shape), and is fixed to the bearing housing 2 as a result that the main body 18a is press-fitted into the through-hole 2b. Further, the shaft 8 is inserted through the main body 18a.

Two annular-shaped projections 18c, 18c are formed on an inner circumferential surface 18b of the main body 18a. Two annular-shaped projections 18c, 18c are separated from each other in the axial direction of the shaft 8. Each of the annular-shaped projections 18c projects to the inside of the bearing holder 18 in the radial direction from the inner circumferential surface 18b, and extends in the circumferential direction of the bearing holder 18 so as to form an annular shape. Further, two large-diameter parts 18d, 18d are provided on the inner circumferential surface 18b. Each of the large-diameter parts 18d is provided on the outside of two annular-shaped projections 18c, 18c in the axial direction of the shaft 8. That is, one large-diameter part 18d is provided on a turbine wheel 9 side (one end part side in the main body 18a) of the annular-shaped projections 18c, 18c, and the other large-diameter part 18d is provided on the compressor wheel 10 side (the other end part side in the main body 18a) of the annular-shaped projections 18c, 18c. The large-diameter part 18d is a site of the inner circumferential surface 18b of the main body 18a, and the site has an inner diameter larger than that of the other sites of the inner circumferential surface 18b.

An oil hole 18f is formed in the main body 18a. The oil hole 18f penetrates through the main body 18a from an outer circumferential surface 18e to the inner circumferential surface 18b, and guides a lubricating oil to the inside of the main body 18a. As the oil hole 18f, an opening on the inner circumferential surface 18b side of the main body 18a lies between two annular-shaped projections 18c (two full-floating metal bearings 19 to be described later).

Moreover, for the bearing housing 2, an oil path 2c is provided. The oil path 2c guides lubricating oil from the outside of the bearing housing 2 to the through-hole 2b. The oil path 2c communicates with the oil hole 18f via the through-hole 2b. Accordingly, the lubricating oil is supplied to the inside of the main body 18a of the bearing holder 18 from the outside of the bearing housing 2 through the oil path 2c and the oil hole 18f.

In the inside of the main body 18a, two full-floating metal bearings 19, 19 are arranged. Two full-floating metal bearings 19, 19 are separated from each other in the axial direction of the shaft 8. Two full-floating metal bearings 19, 19 lie on the outside of the annular-shaped projections 18c, 18c of the bearing holder 18 (that is, either of end part sides of the main body 18a), and lie on the inside of the large-diameter parts 18d, 18d of the bearing holder 18 (that is, the center side of the main body 18a).

The full-floating metal bearing 19 has a metal main body (a bearing main body) 19a in a cylindrical shape. The shaft 8 is inserted through the metal main body 19a. The full-floating metal 19 lies in a gap between the shaft 8 and the bearing holder 18 in the radial direction.

An oil guide hole 19d is formed in the metal main body 19a. The oil guide hole 19d penetrates through the metal main body 19a from an outer circumferential surface 19b to an inner circumferential surface 19c. The oil guide hole 19d is provided in a plurality of numbers, for example, separated in the circumferential direction of the metal main body 19a, and guides lubricating oil toward the outer circumferential surface 19b from the inner circumferential surface 19c of the metal main body 19a. The full-floating metal 19 rotatably supports the shaft 8 by film pressure of the lubricating oil guided to the inner circumferential surface 19c and the outer circumferential surface 19b of the metal main body 19a. Further, the full-floating metal 19 rotates at a rate lower than that of the shaft 8 caused by a flow of the lubricating oil with the rotation of the shaft 8 (so-called corotation).

The lubricating oil is guided to the inside of the main body 18a of the bearing holder 18 via the oil hole 18f. Thereafter, the lubricating oil is supplied to the inner circumferential surface 19c side and the outer circumferential surface 19b side of the metal main body 19a of the full-floating metal 19. On this occasion, a part of the lubricating oil having been guided to the inner circumferential surface 19c side of the metal main body 19a is also guided to the outer circumferential surface 19b side of the metal main body 19a via the oil guide hole 19d.

Into two large-diameter parts 18d, 18d in the bearing holder 18, respectively, thrust bearings 20, 21 are fitted. The thrust bearings 20, 21 are members having a disc-like shape. At the center of the thrust bearing 20, a thrust hole 20a is formed. The thrust hole 20a penetrates through the thrust bearing 20 in the axial direction of the shaft 8. At the center of the thrust bearing 21, a thrust hole 21a is formed. The thrust hole 21a penetrates through the thrust bearing 21 in the axial direction of the shaft 8. The shaft 8 is inserted through these thrust holes 20a, 21a. Further, the thrust bearings 20, 21 are fixed to the main body 18a of the bearing holder 18 caused by being press-fitted into the large-diameter part 18d. Two full-floating metal bearings 19 are regulated in the movement in the axial direction by the annular-shaped projection 18c and the thrust bearings 20, 21.

The collars 22, 23 are arranged, respectively, on the outside relative to two thrust bearings 20, 21 in the axial direction of the shaft 8. In other words, the collars 22, 23 lie on both sides of the thrust bearings 20, 21 paired in the axial direction of the shaft 8. The collar 22 is an annular-shaped projection formed integrally with the shaft 8. The outer diameter of the collar 22 is larger than the inner diameter of the thrust hole 20a of the thrust bearing 20.

The collar 23 is an annular-shaped member provided as a body separated from the shaft 8. The collar 23 has a collar hole 23a penetrating through the collar 23 in the axial direction of the shaft 8. Through the collar hole 23a, the shaft 8 is inserted. The shaft 8 includes a site to be inserted through the thrust bearing 21 and a site on which the collar 23 is installed. The site on which the collar 23 is installed has an outer diameter smaller than that of the site to be inserted through the thrust bearing 21. The difference in the outer diameters of the shaft 8 forms a step surface 8a to the shaft 8. The step surface 8a extends in the radial direction of the shaft 8.

The collar 23 has an edge surface 23b formed on the thrust bearing 20 side. When the collar 23 is installed on the shaft 8, the shaft 8 is inserted through the collar hole 23a of the collar 23 to a position at which the edge surface 23b abuts on the step surface 8a. After that, the collar 23 is sandwiched between the step surface 8a and the compressor wheel 10 and is fixed to the shaft 8.

The thrust bearing 20 has a thrust bearing surface 20b formed as a surface facing the collar 22. Further, the thrust bearing 21 has a thrust bearing surface 21b formed as a surface facing the collar 23. That is, two collars 22, 23 are arranged, respectively, on the outside relative to two thrust bearing surfaces 20b, 21b in the axial direction of the shaft 8. In other words again, two collars 22, 23 lie on both sides of the paired thrust bearing surface 20b, 21b, in the axial direction of the shaft 8.

When a thrust load going toward the right side in FIG. 2 acts on the shaft 8, a film pressure of the lubricating oil is generated between the collar 22 and the thrust bearing surface 20h of the thrust bearing 20, and the thrust bearing 20 receives the thrust load from the collar 22 via the lubricating oil.

On the other hand, when a thrust load going toward the left side in FIG. 2 acts on the shaft 8, the film pressure of the lubricating oil is generated between the collar 23 and the thrust bearing surface 21b of the thrust bearing 21, and the thrust bearing 21 receives the thrust load from the collar 23 via the lubricating oil.

At this time, the thrust bearings 20, 21 are fixed to the bearing holder 18 and are in a non-rotating state, but the collars 22, 23 are in a rotating state. Hereinafter, a flow of the lubricating oil in the bearing structure 7 will be explained, using FIG. 3.

FIG. 3 is a drawing for explaining a flow of the lubricating oil in the embodiment. As shown in FIG. 3, the lubricating oil is supplied to the through-hole 2b from the oil path 2c, and, after that, goes through the oil hole 18f and flows into the inside of the bearing holder 18. At this time, an opening 18g of the oil hole 18f lying on the outer circumferential surface 18e side of the main body 18a lies, as an example, on the lower side of the main body 18a in FIG. 3. On the other hand, an opening 2d of the oil path 2c lying on the bearing holder 18 side faces an site on the upper side of the main body 18a in FIG. 3.

That is, the opening 18g of the oil hole 18f lies at a position different from that of the opening 2d of the oil path 2c in the circumferential direction of the shaft 8. As the result, even when a foreign substance is mixed in the lubricating oil supplied to the through-hole 2b from the oil path 2c, ingression of the foreign substance into the inside of the main body 18a of the bearing holder 18 from the oil hole 18f can be suppressed.

Then, the lubricating oil flows into the inside of the main body 18a of the bearing holder 18 from the oil hole 18f, goes through a gap between the shaft 8 and the annular-shaped projection 18c and is guided to two full-floating metal bearings 19. After that, a part of the lubricating oil, after lubricating the inner circumferential surface 19c of the full-floating metal 19, goes through the oil guide hole 19d and lubricates the outer circumferential surface 19b, too. Further, a part of the lubricating oil directly lubricates the outer circumferential surface 19b without lubricating the inner circumferential surface 19c.

The lubricating oil after lubricating two full-floating metal bearings 19 in this way lubricates both thrust bearing surfaces 20b, 21b of the thrust bearings 20, 21.

In a conventional supply mechanism of lubricating oil, the lubricating oil supplied to a thrust bearing has a comparatively low temperature and high viscosity, and, therefore, influence of viscous resistance of the lubricating oil on mechanical loss is large. In the embodiment, the lubricating oil has a raised temperature caused by lubricating the full-floating metal 19 to thereby exhibit low viscosity. Since lubricating oil with low viscosity is supplied to two thrust bearings 20, 21, mechanical loss caused by the lubricating oil is reduced. In particular, since temperature on the compressor wheel 10 side is lower than that on the turbine wheel 9 side, effect of reducing mechanical loss with temperature rise of the lubricating oil caused by the full-floating metal 19 is high.

Further, in the embodiment, the thrust bearings 20, 21 are fixed to the bearing holder 18 differently from a configuration in which the thrust bearings 20, 21 are fixed to the bearing housing 2. As a result, number of processing steps of the bearing housing 2 can be reduced. Furthermore, for example, a supply passage of the lubricating oil is simplified and processing for forming the supply passage of the lubricating oil becomes easy. Since the thrust bearings 20, 21 are press-fitted and fixed to the bearing holder 18, processing of a screw hole and the like can also be reduced, as compared with screw fixing.

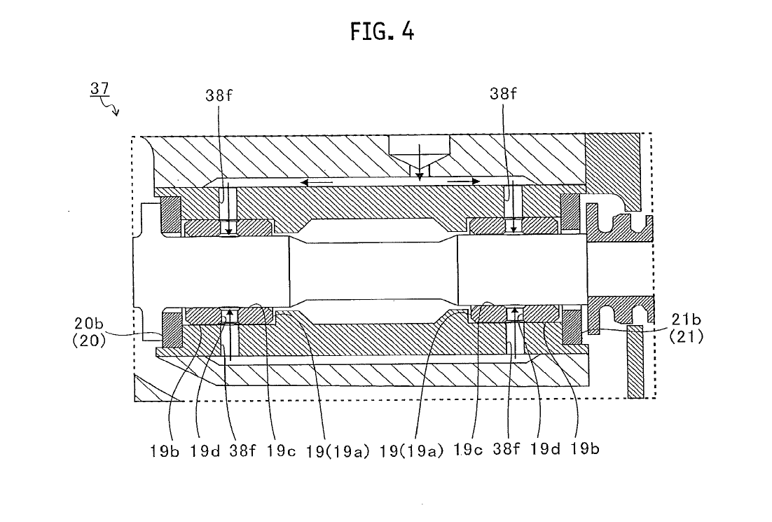

FIG. 4 is a drawing for explaining a flow of lubricating oil in a modified example of the embodiment. As shown in FIG. 4, in a bearing structure 37 in the modified example, an oil hole 38f is formed on the outside of each of two full-floating metal bearings 19 in a radial direction. The oil hole 38f is provided in a plurality of numbers in the circumferential direction of the shaft 8.

Then, the lubricating oil is guided to the full-floating metal 19 via a plurality of oil holes 38f and lubricates the outer circumferential surface 19b side of the full-floating metal 19, and a part of the lubricating oil is guided to the inner circumferential surface 19c side via the oil guide hole 19d to thereby lubricate the inner circumferential surface 19c. After that, the lubricating oil lubricates the thrust bearing surfaces 20b, 21b of the thrust bearings 20, 21.

In this way, similar to the above-mentioned embodiment, in the modified example, too, the lubricating oil with a raised temperature caused by lubricating the full-floating metal 19 lubricates the thrust bearing surfaces 20b, 21b. Accordingly, mechanical loss can be reduced.

Note that, in the embodiment shown in FIG. 3, in a way contrary to the modified example shown in FIG. 4, the lubricating oil flows from the inner circumferential surface 19c of the metal main body 19a toward the outer circumferential surface 19b in the oil guide hole 19d of the full-floating metal 19. Therefore, the flow of the lubricating oil flowing in the oil guide hole 19d is accelerated by centrifugal force, and the lubricating oil can sufficiently supplied to the outer circumferential surface 19b side where, comparatively, the lubricating oil is likely to be short.

Further, since the thrust bearings 20, 21 sandwiches two full-floating metal bearings 19 from the outside in the axial direction of the shaft 8, oil pressure is heightened in both two full-floating metal bearings 19. As the result, the lubricating oil can be supplied to two full-floating metal bearings 19 in a balanced manner.

In the above-mentioned embodiment and the modified example thereof, the main body 18a of the bearing holder 18 is fixed to the bearing housing 2 by being press-fitted into the through-hole 2b of the bearing housing 2. However, for example, movement of the main body 18a of the bearing holder 18 in the axial direction of the shaft 8 may be regulated by performing fixation with a pin etc. With respect to a method for fixing the bearing holder 18 to the bearing housing 2, for example, a plurality of fixing methods such as pressure insertion and pin etc. may be used in combination. In this case, fixing force of the bearing holder 18 to the bearing housing 2 can be enhanced. The main body 18a of the bearing holder 18 may be press-fitted into the through-hole 2b on each of both end sides in the axial direction of the shaft 8, or may be press-fitted into the through-hole 2b on either one side. They may be selected arbitrarily according to operating conditions of the engine etc. However, for example, when only either one of the compressor side and the turbine side has been press-fitted, by reducing the contact area between the bearing holder 18 and the bearing housing 2, propagation of vibration accompanying the rotation of the shaft 8 to the bearing housing 2 can be suppressed. Further, for example, when only the compressor side has been press-fitted, propagation of too much heat from the turbine side to the full-floating metal 19 via the bearing holder 18 can be suppressed.

Further, in the above-described embodiment, the opening 18g of the oil hole 18f lies at a position different from that of the opening 2d of the oil path 2c in the circumferential direction of the shaft 8. However, for example, the opening 18g of the oil hole 18f may be arranged at a position facing the opening 2d of the oil path 2c.

Furthermore, in the embodiment and the modified example thereof, the thrust bearings 20, 21 are formed as bodies separated from the bearing holder 18, and are fixed to the bearing holder 18. However, either one of or both of the thrust bearings 20, 21 may be formed integrally with the bearing holder 18. For example, a configuration in which a part of the bearing holder 18 is made to function as the thrust bearing surfaces 20b, 21b may be sufficient, for example, in such a manner that an end surface of the bearing holder 18 receives a thrust load via the collars 22, 23. Moreover, in this case, for example, a regulatory member such as a retaining ring may be provided separately, for regulating movement on the outside of two full-floating metal bearings 19.

Hereinabove, embodiments of the present invention are explained with reference to the attached drawings, but, needless to say, the present invention is not limited to the embodiment. Obviously, a person skilled in the art may conceive various alteration examples or correction examples in the category described in the claims, and it is understood that these belong to the technical scope of the present invention as a matter of course.

What is claimed is:

1. A bearing structure of a turbocharger including a shaft provided with wheels at both ends, and a housing in which the shaft is accommodated and an oil path for guiding lubricating oil is formed in the inside of the housing, comprising:
a bearing holder fixed in the housing, the bearing holder having a hollow main body provided with an outer circumferential surface and an inner circumferential surface, and an oil hole penetrating through from the outer circumferential surface to the inner circumferential surface of the main body and communicating with the oil path;
two full-floating metal bearings configured to support the shaft, the full-floating metal bearings being arranged in the bearing holder and separately provided from each other in an axial direction of the shaft; and
two thrust bearing surfaces each arranged on an outside of the two full-floating metal bearings in the axial direction of the shaft;
wherein the lubricating oil after lubricating the two full-floating metal bearings lubricates the thrust bearing surfaces.

2. The bearing structure according to claim 1, further comprising a thrust bearing including the thrust bearing surface, the thrust bearing being provided as a body separated from the bearing holder and being fixed to the bearing holder.

3. The bearing structure according to claim 1, wherein:
an opening of the oil hole on an inner circumferential surface side of the main body of the bearing holder lies between the two full-floating metal bearings in the axial direction of the shaft, and wherein;
the two full-floating metal bearings have a metal main body in a cylindrical shape and an oil guide hole that penetrates through from the outer circumferential surface to the inner circumferential surface of the metal main body and guides the lubricating oil from the inner circumferential surface toward the outer circumferential surface.

4. The bearing structure according to claim 2, wherein:
an opening of the oil hole on an inner circumferential surface side of the main body of the bearing holder lies between the two full-floating metal bearings in the axial direction of the shaft, and wherein;
the two full-floating metal bearings have a metal main body in a cylindrical shape and an oil guide hole that penetrates through from the outer circumferential surface to the inner circumferential surface of the metal main body and guides the lubricating oil from the inner circumferential surface toward the outer circumferential surface.

5. The bearing structure according to claim 1, wherein an opening of the oil hole on an outer circumferential surface side of the main body lies at a position different from that of an opening of the oil path on the bearing holder side formed to the housing, in a circumferential direction of the shaft.

6. The bearing structure according to claim 2, wherein an opening of the oil hole on an outer circumferential surface side of the main body lies at a position different from that of an opening of the oil path on the bearing holder side formed to the housing, in a circumferential direction of the shaft.

7. The bearing structure according to claim 3, wherein an opening of the oil hole on an outer circumferential surface side of the main body lies at a position different from that of an opening of the oil path on the bearing holder side formed to the housing, in a circumferential direction of the shaft.

8. The bearing structure according to claim 4, wherein an opening of the oil hole on an outer circumferential surface side of the main body lies at a position different from that of an opening of the oil path on the bearing holder side formed to the housing, in a circumferential direction of the shaft.

9. A turbocharger comprising the bearing structure according to claim 1.

10. A turbocharger comprising:
a housing including an oil path for lubricating oil;
a bearing holder fixed in the housing, the bearing holder having an oil hole communicating with the oil path;
a full-floating metal bearing arranged in the bearing holder; and
a thrust bearing provided in the bearing holder;
wherein the lubricating oil after lubricating the full-floating metal bearing lubricates a thrust bearing surface of the thrust bearing.
